(19) United States
(12) Patent Application Publication
(10) Pub. No.: US 2009/0302605 A1
(43) Pub. Date: Dec. 10, 2009

(54) ENTRANCE FLANGE

(75) Inventor: Börje Stáhl, Kista (SE)

Correspondence Address: BROWDY AND NEIMARK, P.L.L.C.;624 NINTH STREET, NW, SUITE 300, WASHINGTON, DC, 20001-5303, US

(73) Assignee: ITT MANUFACTURING ENTERPRISES INC, Wilmington, DE (US)

(21) Appl. No.: 12/281,697

(22) PCT Filed: Mar. 15, 2007
(86) PCT No.: PCT/SE07/00248

§ 371 Date: Jun. 22, 2009

(30) Foreign Application Priority Data
Apr. 4, 2006 (SE) 0600754-6

(51) Int. Cl. F16L 23/00

(52) U.S. Cl. 285/393

(57) ABSTRACT

The present invention concerns an entrance flange for connecting an elongated member (2) to a component (3), comprising a connection body (5) having means (6, 7) for connecting the entrance flange (1) to the component (3), and a skirt (8) which extends from said connection body (5) and which encloses a member entry hole. The entrance flange is characterized in that it is constituted by at least two separate parts, which are movable in relation to each other in order to allow radial entrance of an elongated member (2) into the member entry hole.

### TECHNICAL FIELD OF THE INVENTION

The present invention relates to an entrance flange for connecting an elongated member to a component, comprising a connection body having means for connecting the entrance flange to the component, and a skirt which extends from said connection body and which encloses a member entry hole, and more precisely to an entrance flange for connecting an electrical cable to a pump.

### BACKGROUND OF THE INVENTION

There are many applications in which an elongated member, such as electrical cables, pipes, etc., has to be fastened or fixed to a component, such as machine housings, structural walls, pumps, etc., and in particular when the member is to be mounted in, and at the same time sealing off, an opening in the housing of the component.

Often the requirement of the connection of the elongated member is that it should not be possible to pull an electric cable or cord out of a machine housing when a non-excessive pulling force is applied on the member. This is a requirement for many applications. In some situations regarding submersible pumps, e.g. the pump could be hanging for a period of time in only the electrical cable even if a chain or wire is arranged for holding the pump. It is then important that the cable cannot be pulled out of the pump housing, or that a gap is formed between the cable and the housing.

Previously it was common that the cable was led through an opening in the pump housing, and the conductors of the cable were connected directly to a terminal block inside the pump housing. A rubber sleeve could be arranged around the cable, which sleeve was axially compressed between an entrance flange and an abutment of the housing, and thus sealing off the gap between the opening of the pump housing and the cable. A drawback with this type of cable attachment is that the cable may move in relation to the rubber sleeve if a high enough pulling force is applied on the cable. Finally the leads of the cable which are connected directly to the terminal block of the pump carries the entire weight of the pump, which may cause severe damage on the equipment. This fastening type also implies that the cable, which could be very long, is more or less permanently fixed to the pump, making it cumbersome to transport and/or handle the pump during maintenance or repair, for instance. For large pumps, the cable is of considerable size and weight, which make the handling even more difficult.

At the present a cable provided with a plug or connector is used, in order to be able to detach the cable from the pump. In some applications the plug presents a flange, which is axially compressed between an entrance flange and an abutment of the pump housing, in order to seal off the interior of the pump. This arrangement also withstands pulling forces on the cable, provided that the cable is more or less permanently connected to the plug. It is vital that the entrance flange is stable and of high strength.

However, a disadvantage is that a certain cable fits several different pumps, at the same time as a certain entrance flange fits several different other pumps. Since the cable is connected to said plug at a first end, and to another plug that is arranged to be connected to the power mains at a second end, the entrance flange needs to be applied around the cable before the plugs are permanently connected to the cable ends. Thereby, each useful combination of a cable and an entrance flange has to be kept in stock. Even if the second end of the cable is free, it is cumbersome to guide the entrance flange the entire way along the cable, upon installation of the pump. One may also connect the plug to the cable upon installation of the pump, but this requires that the installer is certificated and possesses the right knowledge and the right tools. In many cases the customer will install the pump himself and then this solution is not available.

In order to work out some of the abovementioned problems, an entrance flange is known, which has a shape like a U or C, and thereby allows radial entrance of the electric cable into the cable entry hole of the entrance flange. A great disadvantage is however, that the branches of the entrance flange have to be at a great enough distance from each other. In fact, almost half the skirt of the entrance flange, that engages the cable and/or the plug, is removed. When a non-excessive pulling force is applied on the cable, the plug will deflect, since the strength of the entrance flange is weakened due to the slot, and thereby the watertight sealing between the plug and the pump housing is jeopardized.

### SUMMARY OF THE INVENTION

The present invention aims at obviating the aforementioned disadvantages of previously known entrance flanges, and at providing an improved entrance flange. A primary object of the present invention is to provide an improved entrance flange of the initially defined type, which admits an easier attachment around the cable upon connection of the cable to the pump. It is another object of the present invention to provide an entrance flange having an essentially continuous free end of the skirt, in order to achieve an uniform engagement between said skirt and a plug of the cable. It is yet another object of the present invention to provide an entrance flange, which results in a more efficient stock-keeping, both in an economic and in a handling point of view.

According to the invention at least the primary object is attained by means of the initially defined entrance flange having the features defined in the independent claim. Preferred embodiments of the present invention are further defined in the dependent claims.

According to the present invention, there is provided an entrance flange of the initially defined type, which is characterized in that the entrance flange is constituted by at least two separate parts, which are movable in relation to each other in order to allow radial entrance of an elongated member into the member entry hole.

Thus, the present invention is based on the insight of allowing radial entrance of a cable into the through hole of the entrance flange, without losing a stable and reliable connection of the cable to the pump. More precisely, it is important to maintain the strength of the entrance flange, such that the same withstand pulling forces on the cable without deflecting.

In a preferred embodiment of the present invention, the separate parts of the entrance flange are disengagably connected to each other. In another embodiment the two separate parts are complementary shaped, and have the same shape. This facilitates the stock-keeping and manufacturing of the entrance flange, since only one component need to be handled.

### BRIEF DESCRIPTION OF THE DRAWINGS

A more complete understanding of the above mentioned and other features and advantages of the present invention will be apparent from the following detailed description of preferred embodiments in conjunction with the appended drawings, wherein:

FIG. 1 is a perspective view from above of a first embodiment of the entrance flange according to the invention, connecting a cable plug to a machine housing,

FIG. 2 is a perspective view from above of a second embodiment of the entrance flange according to the invention, connecting a cable to a machine housing,

FIG. 3 is a perspective view from above of one of the separate parts of the entrance flange according to the FIG. 1,

FIG. 4 is a perspective view from below of the part of the entrance flange according to the FIG. 3,

FIG. 5 is a perspective view from above of one of the separate parts of the entrance flange according to the FIG. 2,

FIG. 6 is a perspective view from below of the part of the entrance flange according to the FIG. 5,

FIG. 7 is a cross sectional exploded view of the arrangement according to FIG. 2, and

FIG. 8 is a cross sectional view of the arrangement according to FIG. 2, wherein a second embodiment of the entrance flange according to the invention, connects a cable to a machine housing.

### DETAILED DESCRIPTION OF PREFERRED EMBODIMENTS OF THE INVENTION

It should be pointed out that the present invention relates in general to an entrance flange for connecting an elongated member to a component, and in particular to an entrance flange for connecting an electric cable to a contact terminal of a machine housing. Said machine is preferably a submersible machine, such as a pump, a turbine, a mixer, etc. The following description concerns the connection of an electric cable to a submersible pump.

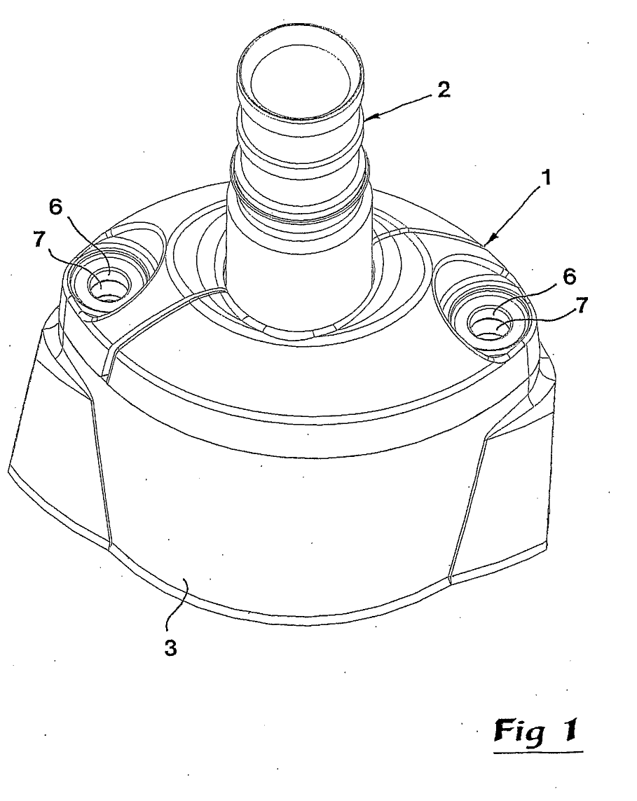

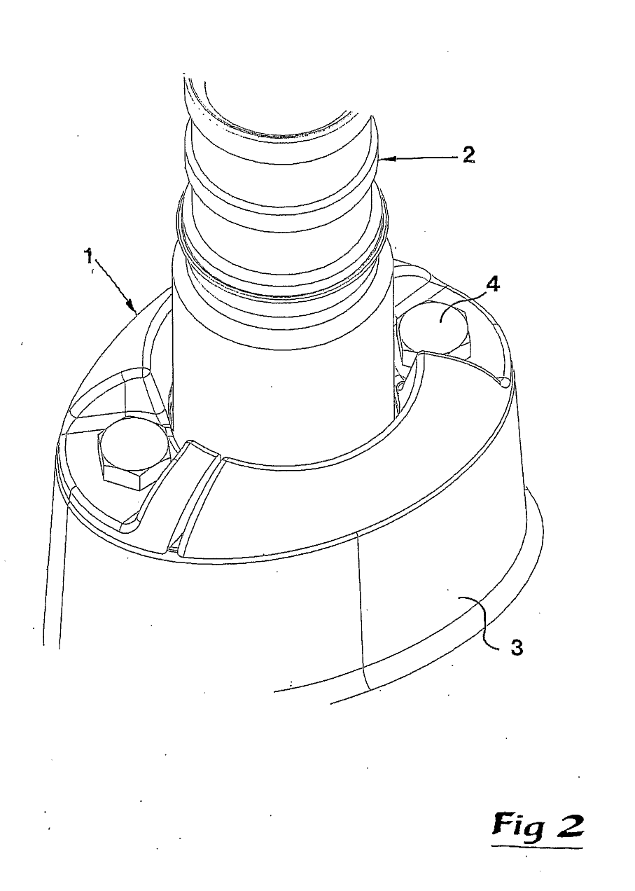

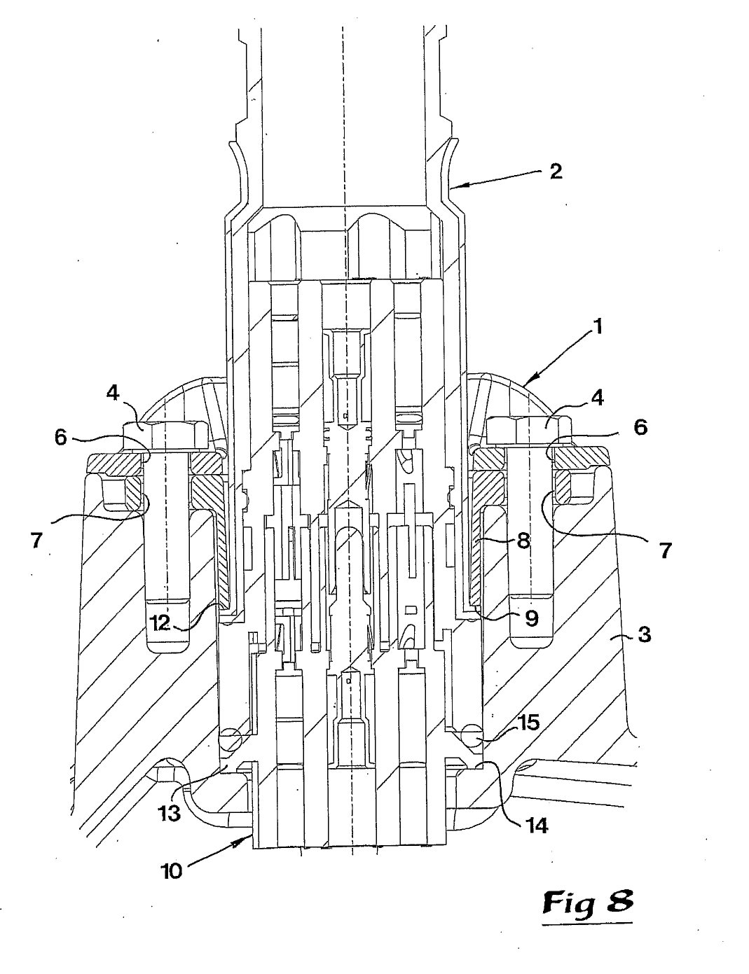

Reference is now made to FIGS. 1 and 2. In FIG. 1 is shown a perspective view from above of a first embodiment of an entrance flange 1 according to the invention, connecting a plug 2 of an electric cable (not shown) to a pump housing 3. In FIG. 2 is shown a corresponding view of a second embodiment of an entrance flange 1 according to the invention. It should be pointed out that only a part of the pump housing 3 is shown, in order to facilitate the reading of the drawings. The plug 2 is arranged to engage a socket (shown in FIGS. 7 and 8) situated in an opening of the pump housing 3, which opening is covered by the entrance flange 1. Of course, it may be a socket which is connected to the electric cable, and which is arranged to engage a plug situated in an opening of the pump housing 3. The main function of the entrance flange 1 is to be stable and to secure the engagement between the plug 2 of the electric cable and the socket of the pump, as well as to secure a watertight connection of the plug 2 to the pump. Moreover, in FIG. 1 the attachment means are removed, but in FIG. 2 the attachment means 4 are present. In the shown embodiment the attachment means 4 are constituted by bolts, but it should be realized that any suitable releasable attachment means may be used, such as clamps, or the like. Each of the entrance flanges 1 according to FIGS. 1 and 2, comprises two separate parts, which jointly encloses the plug 2. In both embodiments the respective entrance flange 1 is constituted by two separate parts of the same configuration and being identical in shape, even though this is not necessary.

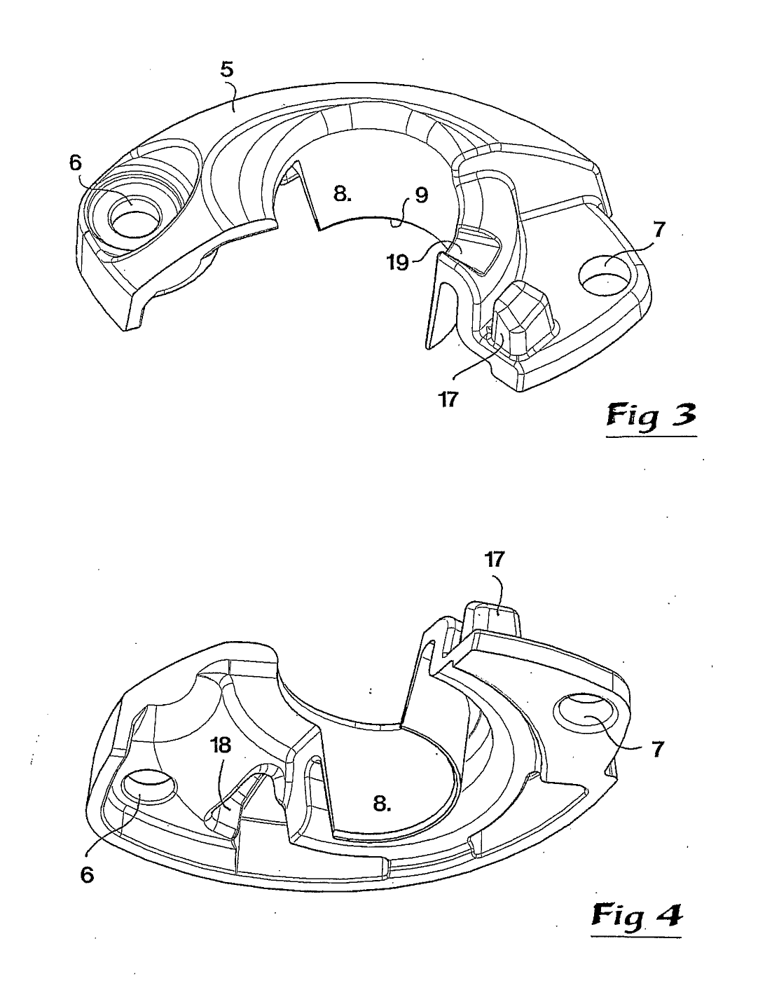

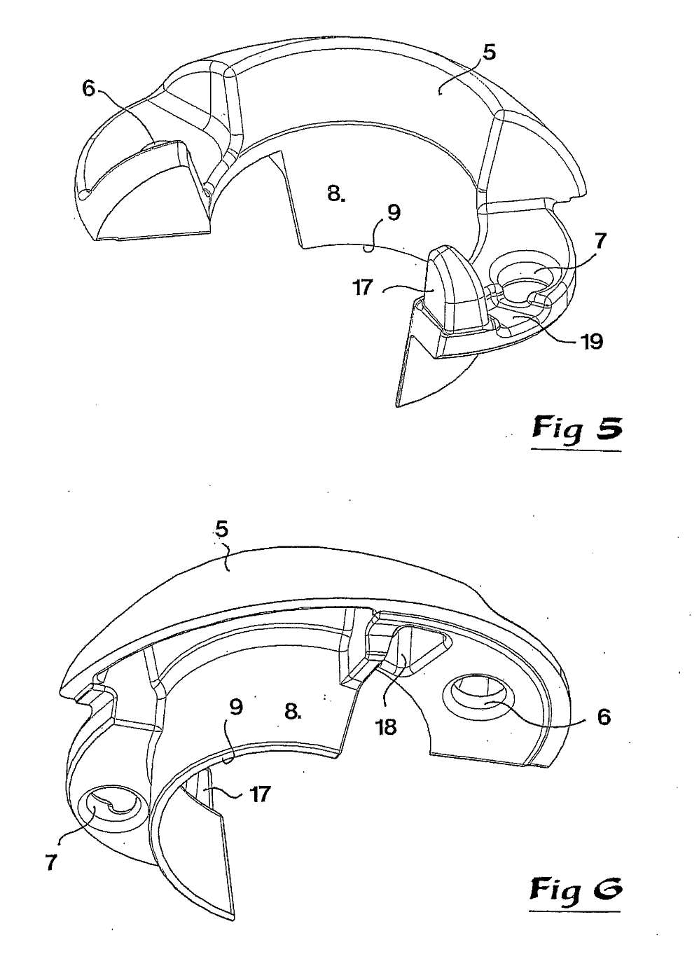

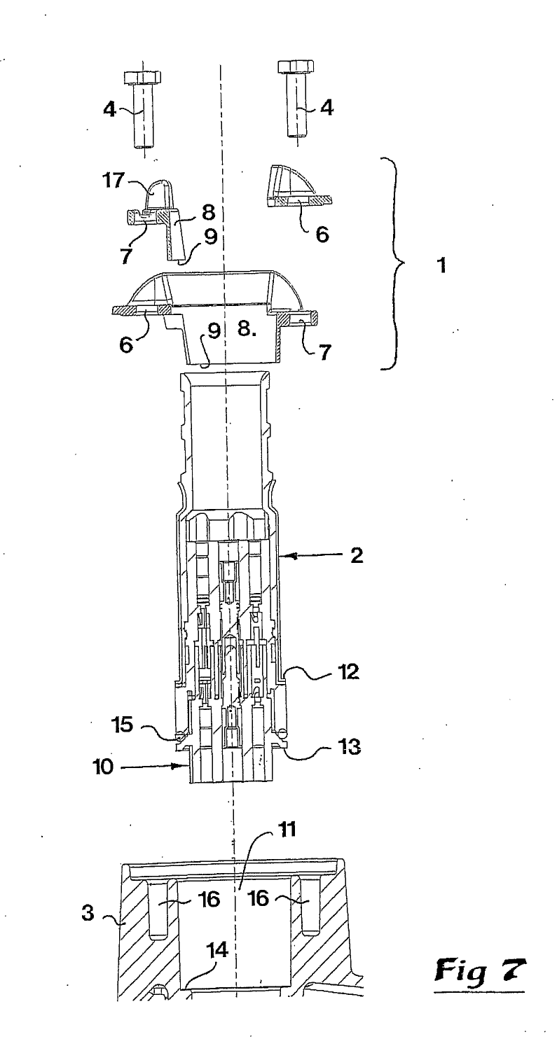

Reference is now also made to FIGS. 3 and 4, as well as to FIGS. 5 and 6. Each FIGS. 3 and 4 show one separate part of the entrance flange 1 according to the first embodiment, in perspective views from above and from below, respectively. FIGS. 5 and 6 shows corresponding views of one separate part of the entrance flange 1 according to the second embodiment. It should be pointed out that corresponding parts of the two embodiments have the same reference sign. The entrance flange 1 comprises a connection body 5 that is arranged to be seated on a mating surface of the pump housing 3. The connection body 5 has means for connecting the entrance flange 1 to the pump housing 3, which in the shown embodiments are wing like extensions of the connection body 5 having upper and lower through holes 6, 7 located therein. As is shown in FIG. 1, the upper through hole 6 of one separate part is arranged to be situated concentric above a lower through hole 7 of the other separate part upon installation. By means of the two sets of cooperating through holes, both separate parts are accurately positioned, in relation to each other as well as in relation to the pump housing 3, by means of fastening means 4. More precisely, the separate parts are fastened to the pump housing 3 by means of common fastening means 4 at two locations each. Furthermore, another function of the connection body 5 is to provide stability and rigidity to the entrance flange 1. Thus, the connection bodies 5 prevents the entrance flange 1, or more precisely the separate parts, from deflecting if a pulling force is applied on the electric cable.

Each separate part comprises a portion of a skirt 8, said portions of the skirt 8 together defining a member entry hole, or a cable entry hole. The skirt 8 extends from the connection body 5, and presents a free lower rim 9. The skirt 8 is arranged to engage the opening of the pump housing 3 by being lowered into said opening. In the shown embodiments, each portion of the skirt 8 constitutes half of the entire skirt 8 when the entrance flange 1 is in assembled mode, even though another distribution is possible. Preferably, the free lower rim 9 is essentially continuous. Of course, there may be gaps between the lower parts of the vertical edges of the two skirt portions, without departing from that the free lower rim 9 is regarded as essentially continuous, as long as the gap is smaller than the diameter of the cable.

Reference is now also made to FIGS. 7 and 8. FIG. 7 is a cross sectional exploded view of the arrangement according to FIG. 2, and in FIG. 8 the parts shown in FIG. 7 are connected to each other. It should be pointed out that the plug 2 is connected to a socket 10, which in real life is connected to conductors that run through the opening 11 of the pump housing 3 and that are connected to a terminal block inside the pump housing 3. Instead of being disconnectable as in the shown embodiment, the socket 10 may as well be fixed in said opening 11. The free lower rim 9 of the skirt 8 is arranged to abut a shoulder 12 of the plug 2. Furthermore, the socket 10 comprises a flange 13 arranged to abut an abutment 14 of the pump housing 3. A gasket 15 is located between the flange 13 of the socket 10 and the plug 2. The flange 13 of the socket may be circular or have any other suitable shape, and preferably planar extending in one plane of propagation. However, it is vital that the abutment 14 of the pump housing 3 has a complementary shape to the flange 13.

Upon connection of the plug 2 to the pump, the two separate parts of the entrance flange 1 are interconnected around the electric cable (not shown) extending from the plug 2. Thereafter, the lower end of the plug 2 and the socket 10 are inserted into the opening 11 of the pump housing 3 until the flange 13 of the socket 10 abuts the abutment 14 of the pump housing 3. Next, the entrance flange 1 is lowered around the plug 2, and the skirt 8 of the entrance flange 1 is introduced in a gap existing between the plug 2 and the pump housing 3, until the free lower rim 9 of the skirt 8 abuts the shoulder 12 of the plug 2. Preferably, the shoulder 12 presents a complementary shape to the free lower rim 9, and preferably they are planar extending in one plane of propagation. The bolts 4 are guided through the upper and lower holes 6, 7 of the two connection bodies 5 and screwed into threaded holes 16 of the pump housing 3. Thereby, the separate parts of the entrance flange 1 are aligned and the free lower rim 9 of the skirt 8 is pressed against the shoulder 12, which results in that the gasket 15 is compressed between the plug 2 and the flange 13 of the socket 10 and the wall of the opening 11, and thereby a watertight connection between the plug 2 and the pump housing 3 is established.

Reference is again made to FIGS. 3-6. The two separate parts of the entrance flange 1 are movable in relation to each other, and in the shown preferred embodiments they are disengagably connectable to each other. Each separate part of the entrance flange 1 may be provided with a pin 17 and an indentation 18, both arranged to engage the indentation 18 and the pin 17, respectively, of the other separate part, in order to allow a preassembly of the two separate parts of the entrance flange 1 around the electric cable. More precisely, to ensure that the two separate parts don't fall apart during installation. More precisely, the separate parts are provided with means, which complement each other in shape for provisional fixation of the entrance flange 1 around the elongated member. In another embodiment, one of the separate parts is provided with only a pin 17 and the other separate part is provided with the indention 18. Furthermore, the pin 17 may be press fitted into the indention 18. The separate parts may also be provided with a recess 19 at a suitable location at the interface between the two separate parts. Upon disassembly of the entrance flange 1, a screwdriver may be inserted into the recess 19 and twisted in order to separate the two separated parts of the entrance flange 1.

The two separate parts of the entrance flange 1 may be articulately connected to each other, e.g. by means of a dismountable hinge or a folding joint in which the entrance flange 1 is folded at a thin bridge of material located between the two separate parts. Furthermore, the two separate parts are complementary shaped in order to establish the appearance of an “undivided” entrance flange, 1, as well as to provide a strong and “solid” entrance flange 1 when assembled. Preferably the two separate parts have the same shape, in order to facilitate the manufacturing and stock keeping.

The portions of the skirt 8 don't need to be solid, as long as the free lower rim 9 is essentially continuous when the entrance flange 1 is assembled, since the function of the skirt 8 is primarily to convey a force from the connection body 5 to the free lower rim 9. An essentially continuous free lower rim 9 of the skirt 8 prevents the plug 2 from tilting or deflecting if a pulling force or bending force is applied on the electric cable, and thereby a watertight connection between the plug 2 and the pump housing 3 is ensured.

### FEASIBLE MODIFICATION OF THE PRESENT INVENTION

The invention is not limited only to the embodiments described above and shown in the drawings. Thus, the entrance flange may be modified in all kinds of ways within the scope of the appended claims.

It shall be pointed out that the entrance flange may comprise more than two separate parts, and the separate parts may be of different size and shape. It is nevertheless important that the entrance flange has a great strength against deflection when assembled, and that the free lower rim of the skirt is essentially continuous.

1. An entrance flange for connecting an elongated member (2) to a component (3), comprising a connection body (5) having means (6, 7) for connecting the entrance flange (1) to the component (3), and a skirt (8) which extends from said connection body (5) and which circumferentially defines a member entry hole into the component (3), characterized in that the entrance flange (1) is constituted by at least two separate parts, which are movable in relation to each other in order to allow radial entrance of the elongated member (2) into the member entry hole.

2. An entrance flange according to claim 1, wherein said separate parts are disengagably connected to each other.

3. An entrance flange according to claim 1, wherein said separate parts are articulately connected to each other.

4. An entrance flange according to claim 3, wherein said separate parts are movable in relation to each other by means of a hinge.

5. An entrance flange according to claim 1, wherein said skirt (8) is circumferential at a free lower rim (9), in order to engage a part of the elongated member (2).

6. An entrance flange according to claim 1, wherein said two separate parts are complementary shaped.

7. An entrance flange according to claim 1, wherein said two separate parts are identical in shape.

8. An entrance flange according to claim 1, wherein the means (6, 7) for connecting the entrance flange (1) to the component (3), are constituted by at least two trough holes (6, 7) arranged to receive attachment members (4), each attachment member (4) passing the through holes (6, 7) of both separate parts.

9. An entrance flange according to claim 1, wherein each of the separate parts is provided with means (17, 18), which complement each other in shape for provisional fixation of the entrance flange (1) around the elongated member (2).

10. An entrance flange according to claim 1, wherein each of said separate parts is provided with a pin (17) and an indentation (18), arrange to engage the indentation (18) and the pin (17), respectively, of the other separate part, in order to achieve provisional fixation of the entrance flange (1) around the component.
